(19) United States
(12) Patent Application Publication
(10) Pub. No.: US 2024/0243274 A1
(43) Pub. Date: Jul. 18, 2024

(54) POSITIVE ELECTRODE FOR NONAQUEOUS ELECTROLYTE SECONDARY BATTERY AND METHOD FOR PRODUCING SAME

(71) Applicant: NICHIA CORPORATION, Anan-shi (JP)

(72) Inventors: Sota SEKIGUCHI, Tokushima-shi (JP); Masahiro MURAYAMA, Tokushima-shi (JP); Rina OZAKI, Anan-shi (JP); Satoshi MATSUSHITA, Tokushima-shi (JP)

(73) Assignee: NICHIA CORPORATION, Anan-shi (JP)

(21) Appl. No.: 18/411,642

(22) Filed: Jan. 12, 2024

(30) Foreign Application Priority Data
Jan. 13, 2023 (JP) 2023-004056

(51) Int. Cl. H01M 4/525; H01M 4/04; H01M 4/36; H01M 4/48; H01M 4/02

(52) U.S. Cl. CPC H01M 4/525; H01M 4/0404; H01M 4/366; H01M 4/48; H01M 2004/021; H01M 2004/028

(57) ABSTRACT

Provided is a method for producing a positive electrode for a nonaqueous electrolyte secondary battery, the method including obtaining a positive electrode active material having a volume-average particle size in a range of 1 m to 8 m and a specific surface area that is 1.4 m²/g or more from: particles containing a lithium transition metal composite oxide; and an aluminum compound having a volume-average particle size in a range of 1 nm to less than 500 nm, and obtaining a positive electrode active material layer by dispersing the positive electrode active material, a conduction aid, and a binder in a solvent to obtain a dispersion, applying the dispersion to the current collector, drying the dispersion, and subsequently compression-molding the dispersion and the current collector to have a density in a range of more than 2.6 g/cm³ and less than 2.8 g/cm³.

### CROSS-REFERENCE TO RELATED PATENT APPLICATION

This application claims priority to Japanese Patent Application No. 2023-004056 filed on Jan. 13, 2023. The disclosures of Japanese Patent Application No. 2023-004056 are hereby incorporated by reference in their entirety.

### TECHNICAL FIELD

The present disclosure relates to a positive electrode for a nonaqueous electrolyte secondary battery and a method for producing the same.

### BACKGROUND ART

Positive electrode active materials for nonaqueous electrolyte secondary batteries for use in large-sized power equipment such as electric vehicles are required to have high output characteristics. To obtain high output characteristics, a positive electrode using a positive electrode active material having a secondary particle structure in which many primary particles are aggregated is effective. In this regard, proposed is a lithium-containing transition metal composite oxide in which the abundance ratio of lithium to oxygen is different between the surface and the inside of a secondary particle (for example, see Patent Document 1). There has also been proposed a lithium transition metal oxide provided with an alumina coating layer on its surface (for example, see Patent Document 2).

### CITATION LIST

### Patent Document

Patent Document 1: JP 2019-99410 A
Patent Document 2: JP 2016-538694 A

### SUMMARY OF INVENTION

### Technical Problem

An object of an aspect of the present disclosure is to provide a positive electrode for a nonaqueous electrolyte secondary battery that provides high output and excellent cycle characteristics in a nonaqueous electrolyte secondary battery, and a method for producing the positive electrode.

### Solution to Problem

A first aspect is a method for producing a positive electrode for a nonaqueous electrolyte secondary battery, the nonaqueous electrolyte secondary battery including a current collector and a positive electrode active material layer disposed on the current collector, the method including:
obtaining a positive electrode active material having a volume-average particle size in a range of 1 μm to 8 μm and a specific surface area that is 1.4 m²/g or more from: particles containing a lithium transition metal composite oxide; and an aluminum compound having a volume-average particle size in a range of 1 nm to less than 500 nm; and
obtaining the positive electrode active material layer by dispersing the positive electrode active material, a conduction aid, and a binder in a solvent to obtain a dispersion, applying the dispersion to the current collector, drying the dispersion, and subsequently compression-molding the dispersion and the current collector to have a density in a range of more than 2.6 g/cm³ and less than 2.8 g/cm³.

A second aspect is a positive electrode for a nonaqueous electrolyte secondary battery, the positive electrode including: a current collector; and a positive electrode active material layer disposed on the current collector, wherein the positive electrode active material layer is obtained from a dispersion containing a positive electrode active material, the positive electrode active material containing: particles containing a lithium transition metal composite oxide; and an aluminum compound having a volume-average particle size in a range of 1 nm to less than 500 nm, the positive electrode active material having a volume-average particle size in a range of 1 μm to 8 μm and a specific surface area that is 1.4 m²/g or more, and wherein the positive electrode active material layer has a density in a range of more than 2.6 g/cm³ and less than 2.8 g/cm³.

### Advantageous Effects of Invention

According to an aspect of the present disclosure, it is possible to provide a positive electrode for a nonaqueous electrolyte secondary battery that provides high output and excellent cycle characteristics in a nonaqueous electrolyte secondary battery, and a method for producing the positive electrode.

### DESCRIPTION OF EMBODIMENTS

The word “step” herein includes not only an independent step, but also a step that cannot be clearly distinguished from another step if the anticipated purpose of the step is achieved. If a plurality of substances applicable to a single component in a composition is present, the content of the single component in the composition means the total amount of the plurality of substances present in the composition, unless otherwise specified. The numeric values of upper and lower limits of numerical ranges described herein can be optionally selected and combined. Embodiments of the present invention will be described below in detail. However, the embodiments described below are merely examples of a positive electrode for a nonaqueous electrolyte secondary battery and a method for producing the positive electrode for embodying the technical concept of the present invention, and the present invention is not limited to the positive electrode for a nonaqueous electrolyte secondary battery and the method for producing the positive electrode described below.

### Method for Producing Positive Electrode for Nonaqueous Electrolyte Secondary Battery

A method for producing a positive electrode for a nonaqueous electrolyte secondary battery including a current collector and a positive electrode active material layer disposed on the current collector of the present disclosure includes:

(Step 1) obtaining a positive electrode active material having a volume-average particle size in a range of 1 μm to 8 μm and a specific surface area that is 1.4 m²/g or more from: particles containing a lithium transition metal composite oxide; and an aluminum compound having a volume-average particle size in a range of 1 nm to less than 500 nm; and

(Step 2) obtaining a positive electrode active material layer by dispersing the positive electrode active material obtained in Step 1, a conduction aid, and a binder in a solvent to obtain a dispersion, applying the dispersion to the current collector, drying the dispersion, and subsequently compression-molding the dispersion and the current collector to have a density of more than 2.6 g/cm³ and less than 2.8 g/cm³.

### Step 1: Production of Positive Electrode Active Material

Step 1 is a step of producing a positive electrode active material. The step of producing a positive electrode active material may include a preparation step of preparing particles containing a lithium transition metal composite oxide, and a mixing step of mixing the particles containing the lithium transition metal composite oxide with an aluminum compound having an average particle size in a range of 1 nm to less than 500 nm to obtain a mixture. The particles containing a lithium transition metal composite oxide to be prepared may have a volume-average particle size in a range of 1 μm to 8 μm and a specific surface area of 1.3 m²/g or more.

### Preparation Step

In the preparation step, particles containing a desired lithium transition metal composite oxide (hereinafter, also simply referred to as “lithium transition metal composite oxide particles”) are prepared. The lithium transition metal composite oxide particles may be prepared by purchase or the like, or may be prepared by being produced by a method for producing a lithium transition metal composite oxide described below or the like. Details and preferable embodiments of the lithium transition metal composite oxide particles to be prepared will be described later.

### Mixing Step

In the mixing step, the lithium transition metal composite oxide particles and an aluminum compound are mixed to obtain a mixture. The resulting mixture may be a positive electrode active material for a nonaqueous electrolyte secondary battery. Mixing of the lithium transition metal composite oxide particles and the aluminum compound may be performed by dry mixing using, for example, a high-speed shearing mixer. The mixing temperature may be, for example, in a range of 10° C. to 100° C., and preferably in a range of 25° C. to 60° C.

The volume-average particle size of the aluminum compound used in the mixing step may be, for example, in a range of 1 nm to less than 500 nm. Details and preferable embodiments of the aluminum compound will be described later.

The mixing amount of the aluminum compound mixed with the lithium transition metal composite oxide particles in the mixing step may be, for example, 2 mol % or less, preferably 1.8 mol % or less, 1.5 mol % or less, or 1.0 mol % or less with respect to 1 mol of the lithium transition metal composite oxide. The mixing amount of the aluminum compound in the mixing step may be, for example, 0.01 mol % or more, and preferably 0.05 mol % or more, 0.1 mol % or more, or 0.3 mol % or more with respect to 1 mol of the lithium transition metal composite oxide.

The step of producing a positive electrode active material may further include mixing the lithium transition metal composite oxide particles and a tungsten compound. The mixing of the lithium transition metal composite oxide particles and the tungsten compound may be performed simultaneously with the mixing of the lithium transition metal composite oxide particles and the aluminum compound, or may be performed separately and sequentially. From the viewpoint of flowability, it is preferable to perform mixing with the aluminum compound, then perform mixing with the tungsten compound. The mixing of the lithium transition metal composite oxide particles and the tungsten compound may be performed by dry mixing using, for example, a high-speed shearing mixer. The mixing temperature may be, for example, in a range of 10° C. to 100° C., and preferably in a range of 25° C. to 60° C.

The volume-average particle size of the tungsten compound used for mixing with the lithium transition metal composite oxide particles may be, for example, in a range of 0.05 μm to 2 μm. Details and preferable embodiments of the tungsten compound will be described later.

The mixing amount of the tungsten compound mixed with the lithium transition metal composite oxide particles may be, for example, in a range of 0.1 mol % to 2 mol % with respect to 1 mol of the lithium transition metal composite oxide. Preferably, the mixing amount of the tungsten compound may be 1.8 mol % or less, 1.5 mol % or less, or 1.0 mol % or less, and may be 0.2 mol % or more, or 0.3 mol % or more with respect to 1 mol of the lithium transition metal composite oxide.

The method for producing a positive electrode active material may further include a drying step, a sizing step, and the like after the mixing step.

The method for producing a positive electrode active material preferably does not include a heat treatment step of heat treating the mixture containing the lithium transition metal composite oxide particles and the aluminum compound. Not including the heat treatment step can favorably maintain the flowability of the positive electrode active material. Here, the heat treatment step means that the mixture containing the lithium transition metal composite oxide particles and the aluminum compound is held at a temperature of, for example, 300° C. or more, or 200° C. or more, for example, for 2 hours or more, or 30 minutes or more. Thus, in the present specification, obtaining the mixture at a temperature of, for example, 150° C. or less does not correspond to the heat treatment.

### Positive Electrode Active Material

The positive electrode active material obtained in Step 1 includes: particles containing a lithium transition metal composite oxide; and an aluminum compound having an average particle size in a range of 1 nm to less than 500 nm, the positive electrode active material having a volume-average particle size in a range of 1 μm to 8 μm and a specific surface area of 1.4 m²/g or more.

The positive electrode active material, having a relatively small particle size and a large specific surface area, can achieve excellent output characteristics, for example, a reduced direct-current resistance in a low-temperature environment when the positive electrode active material constitutes a nonaqueous electrolyte secondary battery. In addition, since the aluminum compound is contained, the flowability as a powder is excellent even though the specific surface area is large, and thus, the positive electrode active material has favorable process flowability and is excellent in the productivity in the production step. It can be considered that this is because, for example, when the aluminum compound is contained, the steric hindrance between the particles is increased and the aggregation is suppressed.

The positive electrode active material may have a volume-average particle size in a range of 1 μm to 8 μm, preferably 1.2 μm or more, 1.5 μm or more, 2 μm or more, 2.5 μm or more, 3 μm or more, or 3.5 μm or more, and preferably 6 μm or less, 5 μm or less, 4.7 μm or less, or 4.5 μm or less from the viewpoint of the output characteristics of the nonaqueous electrolyte secondary battery. In an aspect, the volume-average particle size may be in a range of 2 μm to 6 μm. The volume-average particle size of the positive electrode active material is determined as a particle size corresponding to a volume accumulation of 50% from the small size side in a volume-based cumulative particle size distribution. The volume-based cumulative particle size distribution is measured by, for example, a laser diffraction particle size distribution analyzer (SALD-3100 manufactured by Shimadzu Corporation).

The positive electrode active material may have a specific surface area measured by the BET method of 1.4 m²/g or more, preferably 1.7 m²/g or more, 1.9 m²/g or more, 2.0 m²/g or more, or 2.5 m²/g or more from the viewpoint of the output characteristics of the nonaqueous electrolyte secondary battery. The specific surface area may be, for example, 4.0 m²/g or less, preferably 3.8 m²/g or less, 3.3 m²/g or less, or 3.0 m²/g or less. In an aspect, the specific surface area of the positive electrode active material may be, for example, in a range of 1.7 m²/g to 3.8 m²/g, preferably in a range of 1.7 m²/g to 3.3 m²/g, or in a range of 1.9 m²/g to 3.0 m²/g. The specific surface area measured by the BET method is measured by a one-point method using nitrogen gas based on the Brunauer Emmett Teller (BET) theory.

From the viewpoint of flowability, the positive electrode active material as a powder may have an angle of repose of, for example, less than 70°, preferably 68° or less, or 67° or less. The lower limit of the angle of repose may be, for example, 50° or more, or 60° or more. From the viewpoint of flowability, the positive electrode active material as a powder may have an angle of fall of, for example, less than 68°, and preferably 66° or less, or 610 or less. The lower limit of the angle of fall may be, for example, 400 or more, or 450 or more. Further, from the viewpoint of flowability, the positive electrode active material may have an angle of difference obtained by subtracting the angle of fall from the angle of repose of, for example, 3° or more, preferably 6° or more, or 8° or more. The upper limit of the angle of difference may be, for example, 250 or less, or 200 or less.

Here, the “angle of repose (01)” means an angle of inclination when a powder of the positive electrode active material is piled on a measurement table. Examples of a method for piling the powder of the positive electrode active material include a typical injection method. The “angle of fall (02)” means an angle of inclination measured after a predetermined impact force is applied to the measurement table after the angle of repose (01) is measured. For the measurement of the angle of repose (01) and the angle of fall (02), for example, a powder characteristic measuring instrument (for example, Powder Tester (trade name); manufactured by Hosokawa Micron Corporation) can be used.

A specific method for measuring the angle of repose (01) and the angle of fall (02) is as follows.

### Method for Measuring Angle of Repose

A powder to be measured was dropped from a funnel at a predetermined height onto a horizontal substrate (measurement table), and the base angle was calculated from the diameter and height of the formed conical pile, and this base angle was defined as the angle of repose. It can be typically measured based on JIS-R9301-2-2.

### Method for Measuring Angle of Fall

The conical pile whose angle of repose has been measured is collapsed by applying a predetermined impact to the measurement table three times, then the base angle is calculated from the diameter and height of the conical pile, and this base angle is defined as the angle of fall. Here, the predetermined impact is an impact employed in the measuring apparatus used, and is specific to the apparatus and constant.

### Method for Measuring Angle of Difference

The angle of difference was calculated by the following formula:

$$Angle of repose ( ° ) - Angle of fall ( ° ) = Angle of difference ( ° )$$

### Lithium Transition Metal Composite Oxide

The particles containing a lithium transition metal composite oxide constituting the positive electrode active material (hereinafter, also simply referred to as “lithium transition metal composite oxide particles”) may be, for example, secondary particles formed by aggregation of a plurality of primary particles containing the lithium transition metal composite oxide. The lithium transition metal composite oxide particles having a predetermined volume-average particle size and a predetermined specific surface area improve output characteristics in a nonaqueous electrolyte secondary battery formed by using the positive electrode active material containing the lithium transition metal composite oxide particles. Thus, in an aspect, the positive electrode active material may be composed of lithium transition metal composite oxide particles having a predetermined volume-average particle size and specific surface area.

The volume-average particle size (D50) of the lithium transition metal composite oxide particles may be, for example, in a range of 1 μm to 8 μm, preferably 1.2 μm or more, 1.5 μm or more, 2 μm or more, 2.5 μm or more, 3 μm or more, or 3.5 μm or more, and preferably 6 μm or less, 5 μm or less, 4.7 μm or less, or 4.5 μm or less. In an aspect, the volume-average particle size may be in a range of 2 μm to 6 μm. The lithium transition metal composite oxide particles having a volume-average particle size within the above range have favorable flowability as a positive electrode active material and may further improve the output characteristics when constituting a nonaqueous electrolyte secondary battery. Here, in the same manner as in the positive electrode active material, the volume-average particle size of the lithium transition metal composite oxide particles is measured by, for example, a laser diffraction particle size distribution measuring device (SALD-3100 manufactured by Shimadzu Corporation), and is obtained as a particle size corresponding to a volume cumulative 50% from the small size side in a volume-based cumulative particle size distribution.

The positive electrode active material is formed of lithium transition metal composite oxide particles and nanoparticles of an aluminum compound. Thus, the volume-average particle size of the lithium transition metal composite oxide particles may be substantially the same as the volume-average particle size of the positive electrode active material.

The lithium transition metal composite oxide particles are formed by aggregation of a plurality of primary particles. The average particle size D_{SEM} of the primary particles based on electron microscope observation is, for example, in a range of 0.1 μm to 1.5 μm, preferably 0.12 μm or more, and more preferably 0.15 μm or more. The average particle size D_{SEM} of the primary particles based on electron microscopic observation is preferably 1.2 μm or less, and more preferably 1.0 μm or less. The primary particles having an average particle size based on electron microscope observation within the above range may improve the output when constituting a nonaqueous electrolyte secondary battery.

The specific surface area measured by the BET method of the lithium transition metal composite oxide particle may be 1.3 m²/g or more, preferably 1.5 m²/g or more, 1.7 m²/g or more, or 1.9 m²/g or more from the viewpoint of the output characteristics of the nonaqueous electrolyte secondary battery. The specific surface area may be, for example, 3.9 m²/g or less, preferably 3.5 m²/g or less, 3.3 m²/g or less, or 2.8 m²/g or less. The lithium transition metal composite oxide particles having a specific surface area within the above range further improve the output characteristics and may further enhance the effect of improving the flowability when the aluminum compound is added.

The positive electrode active material is formed of: secondary particles which are particles containing a lithium transition metal composite oxide; and nanoparticles of an aluminum compound. Thus, the specific surface area of the lithium transition metal composite oxide particles may be substantially the same as the specific surface area of the positive electrode active material, or may be in a range of 80% to 110% of the specific surface area of the positive electrode active material.

The lithium transition metal composite oxide particles may be secondary particles formed by aggregation of a plurality of primary particles, and may have voids therein. This can easily achieve a predetermined specific surface area and may further improve the output characteristics of the nonaqueous electrolyte secondary battery. The fact that the lithium transition metal composite oxide particles have voids inside can be evaluated from, for example, a sectional image thereof. The sectional image of the particles can be obtained using, for example, a scanning electron microscope (SEM).

When the lithium transition metal composite oxide particles have voids inside, the degree of the voids can be evaluated by, for example, the porosity. The porosity is an index of the abundance ratio of a space portion formed inside the secondary particles composed of the lithium transition metal composite oxide, and is measured by observing a section of the secondary particles. The porosity of the lithium transition metal composite oxide particles may be, for example, in a range of 10% to 50%, in a range of 15% to 50%, or in a range of 20% to 50%. By controlling the porosity within this range, the contact area with the electrolyte can further increase even when the specific surface area is about the same, and a positive electrode active material having more excellent output characteristics can be obtained. Thus, a secondary battery having a further improved output density per volume is obtained. The porosity of the lithium transition metal composite oxide particles may be preferably in a range of 25% to 45%, 27% or more, 29% or more, or 30% or more, and may be 40% or less, or 38% or less.

The porosity of the secondary particles can be measured by observing any section of the secondary particles using a scanning electron microscope (SEM) and performing image analysis. Specifically, a plurality of secondary particles are embedded in a resin or the like, a sectional sample is produced by cross section polisher processing or the like, and the section of the secondary particles can be observed with a scanning electron microscope. Thereafter, any 100 secondary particles having a sectional size within ±1 μm of the volume-average particle size (D50) of the lithium transition metal composite oxide particles are selected. For each secondary particle, using image analysis software (for example, HALCON; manufactured by MVTec), a void portion (space portion) in the secondary particle is detected in white, and a dense portion in the contour of the secondary particle is detected in black. The porosity can be calculated by calculating the total area of the white portions and the total area of the black portions of the selected 100 secondary particles, and calculating the area ratio of the space portion to the sectional area of the secondary particles [white portion/(white portion+black portion)]. The porosity of the secondary particles of the positive electrode active material for a nonaqueous electrolyte secondary battery containing the aluminum compound is equivalent to the porosity of the secondary particles (base material) composed of the lithium transition metal composite oxide.

The lithium transition metal composite oxide constituting the positive electrode active material may contain, for example, lithium (Li) and nickel (Ni) in its composition and may have a layered structure. The lithium transition metal composite oxide may contain at least lithium (Li) and nickel (Ni), and may further contain cobalt (Co). The lithium transition metal composite oxide may further contain at least one first metal element selected from the group consisting of aluminum (Al) and manganese (Mn). The lithium transition metal composite oxide may further contain, in addition to these elements, at least one second metal element selected from the group consisting of magnesium (Mg), calcium (Ca), titanium (Ti), zirconium (Zr), niobium (Nb), tantalum (Ta), chromium (Cr), molybdenum (Mo), tungsten (W), iron (Fe), copper (Cu), silicon (Si), tin (Sn), bismuth (Bi), gallium (Ga), yttrium (Y), samarium (Sm), erbium (Er), cerium (Ce), neodymium (Nd), lanthanum (La), cadmium (Cd), and lutetium (Lu). The second metal element may be at least one selected from the group consisting of zirconium (Zr), titanium (Ti), magnesium (Mg), tantalum (Ta), niobium (Nb), molybdenum (Mo), and tungsten (W).

In the lithium transition metal composite oxide, the ratio of the number of moles of nickel to the total number of moles of metal elements other than lithium may be, for example, more than 0, preferably 0.33 or more. The ratio of the number of moles of nickel to the total number of moles of metal elements other than lithium may be 0.4 or more, or 0.45 or more. The ratio of the number of moles of nickel to the total number of moles of metal elements other than lithium may be, for example, less than 1, and preferably 0.95 or less, 0.8 or less, or 0.6 or less. When the ratio of the number of moles of nickel is within the above range, sufficient charge-discharge capacity at a high voltage and excellent cycle characteristics can be achieved in the nonaqueous electrolyte secondary battery.

When the lithium transition metal composite oxide contains cobalt, the ratio of the number of moles of cobalt to the total number of moles of metal elements other than lithium may be, for example, more than 0, preferably 0.01, and more preferably 0.02 or more, 0.05 or more, 0.1 or more, or 0.15 or more. The ratio of the number of moles of cobalt to the total number of moles of metal elements other than lithium may be, for example, less than 1, and preferably 0.6 or less, 0.4 or less, or 0.35 or less. The ratio of the number of moles of cobalt to the total number of moles of metal elements other than lithium may be 0.33 or less, 0.3 or less, or 0.25 or less. When the ratio of the number of moles of cobalt is within the above-described range, a sufficient charge-discharge capacity at a high voltage can be achieved in the nonaqueous electrolyte secondary battery.

When the lithium transition metal composite oxide contains at least one of manganese and aluminum, the ratio of the total number of moles of manganese and aluminum to the total number of moles of metal elements other than lithium may be, for example, more than 0, preferably 0.01 or more, and more preferably 0.05 or more, 0.1 or more, or 0.15 or more. The ratio of the total number of moles of manganese and aluminum to the total number of moles of metal elements other than lithium may be, for example, 0.6 or less, and preferably 0.35 or less. The ratio of the total number of moles of manganese and aluminum to the total number of moles of metal elements other than lithium may be 0.33 or less, or 0.3 or less. When the ratio of the total number of moles of manganese and aluminum is within the above-described range, both high charge-discharge capacity and safety in the nonaqueous electrolyte secondary battery can be achieved.

The ratio of the number of moles of lithium to the total number of moles of metal elements other than lithium in the lithium transition metal composite oxide may be, for example, 0.95 or more, and preferably 1.0 or more, 1.03 or more, or 1.05 or more. The ratio of the number of moles of lithium to the total number of moles of metal elements other than lithium may be, for example, 1.5 or less, and preferably 1.3 or less, 1.25 or less, or 1.2 or less. When the ratio of the number of moles of lithium is 0.95 or more, the interface resistance generated at the interface between the positive electrode surface and the nonaqueous electrolyte in the nonaqueous electrolyte secondary battery using the positive electrode active material containing the lithium transition metal composite oxide to be obtained is suppressed, and thus, the output of the nonaqueous electrolyte secondary battery tends to improve. When the ratio of the number of moles of lithium is 1.5 or less, the initial discharge capacity tends to improve when the positive electrode active material is used for the positive electrode of a nonaqueous electrolyte secondary battery.

When the lithium transition metal composite oxide contains cobalt and manganese in addition to nickel, the ratio of the number of moles of nickel, cobalt, and manganese may be, for example, nickel:cobalt:manganese=(0.33 to 0.95):(0.02 to 0.6):(0.01 to 0.35), preferably (0.33 to 0.8):(0.05 to 0.35):(0.05 to 0.35). When the lithium transition metal composite oxide contains cobalt, manganese, and aluminum in addition to nickel, the ratio of the number of moles of nickel, cobalt, and (manganese+aluminum) may be, for example, nickel:cobalt:(manganese+aluminum)=(0.33 to 0.95):(0.02 to 0.6):(0.01 to 0.35), and preferably (0.33 to 0.8):(0.05 to 0.35):(0.05 to 0.35).

When the lithium transition metal composite oxide contains at least one second metal element, the ratio of the total number of moles of the second metal element to the total number of moles of metal elements other than lithium may be, for example, more than 0, preferably 0.001 or more, or 0.003 or more. The ratio of the total number of moles of the second metal element to the total number of moles of metal elements other than lithium may be, for example, 0.05 or less, and is preferably 0.02 or less or 0.015 or less. In particular, when tungsten is contained as the second metal element, particles having a higher porosity tend to be obtained by setting the ratio of the number of moles of tungsten to the total number of moles of metal elements other than lithium to be in a range of 0.05 to 0.15.

The lithium transition metal composite oxide may have, for example, a composition represented by Formula (1) shown below. The lithium transition metal composite oxide may have a layered structure or may have a hexagonal crystal structure.

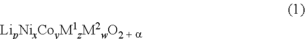

Here, p, x, y, z, w, and α satisfy 1.0≤p≤1.3, 0≤x≤1, 0≤y≤1, 0≤z≤1, 0≤w≤0.05 x+y+z=1, and −0.1≤α≤0.1. x, y, z, and w may satisfy 0<x<1, 0≤y≤0.6, 0≤z≤0.6, 0≤w≤0.05, may satisfy 0.33≤x≤0.95, 0.01≤y≤0.6, 0≤z≤0.35, 0≤w≤0.05, or may satisfy 0.33≤x≤0.8, 0.02≤y≤0.35, 0.05≤z≤0.35, 0≤w≤0.02.

M¹ may represent at least one of Mn or Al. M² may represent at least one selected from the group consisting of Mg, Ca, Ti, Zr, Nb, Ta, Cr, Mo, W, Fe, Cu, Si, Sn, Bi, Ga, Y, Sm, Er, Ce, Nd, La, Cd, and Lu, and may represent at least one selected from the group consisting of Zr, Ti, Mg, Ta, Nb, Mo, and W.

When M² contains Zr, the content thereof may be 0.1 mol % or more or 0.3 mol % or more, and may be 1.0 mol % or less or 0.7 mol % or less. When the content of Zr is in the above-described range, there is a tendency that a battery having higher durability can be configured. When M² contains W, the content thereof may be 0.1 mol % or more or 0.3 mol % or more, and may be 2.0 mol % or less or 1.0 mol % or less. When the content of W is in the above-described range, there is a tendency that a battery having higher output characteristics can be configured.

The content of the lithium transition metal composite oxide particles in the positive electrode active material may be, for example, 80 mass % or more, preferably 90 mass % or more, or 95 mass % or more. The upper limit of the content of the lithium transition metal composite oxide particles in the positive electrode active material may be, for example, less than 100 mass %, 99 mass % or less, or 98 mass % or less.

### Method For Producing Lithium Transition Metal Composite Oxide

The lithium transition metal composite oxide particles used in the method for producing a positive electrode active material can be produced by, for example, the following production method. The method for producing a lithium transition metal composite oxide may include a composite oxide preparation step of preparing a composite oxide containing nickel, and a synthesis step of mixing the composite oxide containing nickel and a lithium compound and heat treating the mixture to obtain a lithium transition metal composite oxide containing lithium and nickel and having a layered structure. The lithium transition metal composite oxide to be produced may contain secondary particles formed by aggregation of a plurality of primary particles containing the lithium transition metal composite oxide.

### Composite Oxide Preparation Step

In the composite oxide preparation step, a composite oxide containing nickel (hereinafter, also simply referred to as “nickel composite oxide”) is prepared. The nickel composite oxide to be prepared may contain secondary particles formed by aggregation of a plurality of primary particles containing the nickel composite oxide. The nickel composite oxide may be prepared by purchase or the like, or may be produced and prepared by a method for producing a nickel composite oxide described below. Details of the nickel composite oxide to be prepared will be described later.

### Synthesis Step

The synthesis step includes mixing the prepared nickel composite oxide and a lithium compound to obtain a lithium mixture, and heat treating the lithium mixture to obtain a lithium transition metal composite oxide containing lithium and nickel and having a layered structure. In the synthesis step, the lithium transition metal composite oxide may be obtained by diffusing lithium contained in the lithium compound into the nickel composite oxide.

Examples of the method for mixing the nickel composite oxide and the lithium compound include a method in which the nickel composite oxide and the lithium compound are dry-mixed using a stirring mixer or the like, and a method in which a slurry of the nickel composite oxide is prepared and wet-mixed using a mixer such as a ball mill. Examples of the lithium compound include lithium hydroxide, lithium nitrate, lithium carbonate, and mixtures thereof.

The ratio of the number of moles of lithium to the total number of moles of metal elements other than lithium in the lithium mixture (hereinafter, also referred to as lithium ratio) may be, for example, in a range of 0.9 to 1.3, and is preferably in a range of 1 to 1.2. When the lithium ratio is 0.9 or more, the formation of by-products tends to be suppressed. When the lithium ratio is 1.3 or less, an increase in the amount of the alkali component present on the surface of the lithium mixture is suppressed, moisture adsorption due to deliquescence of the alkali component is suppressed, and there is a tendency that handling properties improve.

In the mixing of the nickel composite oxide and the lithium compound, in addition to the lithium compound, a simple substance, an alloy, or a compound containing a second metal element of at least one second metal element selected from the group consisting of magnesium, calcium, titanium, zirconium, niobium, tantalum, chromium, molybdenum, tungsten, iron, copper, silicon, tin, bismuth, gallium, yttrium, samarium, erbium, cerium, neodymium, lanthanum, cadmium, and lutetium may be further mixed. Examples of the compound containing the second metal element include hydroxides, oxides, and carbonates. The second metal element may be at least one selected from the group consisting of zirconium, titanium, magnesium, tantalum, niobium, molybdenum, and tungsten. In particular, when tungsten is contained as the second metal element, there is a tendency that particles having a higher porosity can be obtained and a battery having high output characteristics can be configured. Thus, tungsten is preferably contained.

The heat treatment temperature in the synthesis step may be, for example, in a range of 650° C. to 990° C., and preferably 700° C. or more, 730° C. or more, or 760° C. or more. The heat treatment temperature may be preferably 960° C. or less, 940° C. or less, or 920° C. or less. The heat treatment of the mixture may be performed at a single temperature, but is preferably performed at a plurality of temperatures from the viewpoint of particle control. When the heat treatment is performed at a plurality of temperatures, for example, it is desirable that the first temperature is held for a predetermined time, then the temperature is further raised, and the second temperature is held for a predetermined time. The first temperature is, for example, in a range of 650° C. to 850° C., preferably in a range of 700° C. to 820° C., and the second temperature is, for example, in a range of 730° C. to 960° C., preferably in a range of 760° C. to 920° C. When the heat treatment temperature is 650° C. or more, an increase in unreacted lithium content tends to be suppressed. When the heat treatment temperature is 990° C. or less, decomposition of the generated lithium transition metal composite oxide tends to be suppressed. From the viewpoint of obtaining a lithium transition metal composite oxide having a high porosity, the heat treatment is preferably performed at a temperature in a range of 800° C. to 980° C. for 8 hours or more, more preferably performed at a temperature in a range of 810° C. to 920° C. for 8 hours or more, and the time of the heat treatment may be, for example, 20 hours or less. The heat treatment time may be, for example, 2 hours or more, preferably 4 hours or more, or 6 hours or more as a time for holding the maximum temperature. The heat treatment time may be, for example, 20 hours or less, preferably 18 hours or less, or 12 hours or less, and when the heat treatment is performed at a plurality of temperatures, the heat treatment time may be in a range of 1 hour to 19 hours. The atmosphere for the heat treatment may be in the presence of oxygen, and is preferably an atmosphere containing oxygen in a range of 10 vol % to 100 vol %.

In the method for producing a lithium transition metal composite oxide, after the synthesis step, a heat-treated product obtained as necessary may be subjected to treatments such as rough grinding, pulverization, and dry sieving.

### Method For Producing Nickel Composite Oxide

The method for producing a nickel composite oxide may include, for example, a first solution preparation step of preparing a first solution containing nickel ions and optionally cobalt ions or the like, a second solution preparation step of preparing a second solution containing a complex ion forming factor, a liquid medium preparation step of preparing a liquid medium having a pH in a range of 10 to 13.5, a crystallization step of obtaining a reaction solution in which the pH is maintained in a range of 10 to 13.5 while separately and simultaneously supplying the first solution and the second solution to the liquid medium, a composite hydroxide recovery step of obtaining a composite hydroxide containing nickel from the reaction solution, and a composite hydroxide heat treatment step of heat treating the resulting composite hydroxide to obtain a nickel composite oxide. For details of the method for obtaining such a composite oxide, reference can be made to, for example, JP 2003-292322 A, JP 2011-116580 A (US 2012/270107 A), and the like.

### First Solution Preparation Step

In the first solution preparation step, a first solution containing nickel ions and optionally cobalt ions or the like is prepared. The first solution is prepared by dissolving a predetermined amount of a salt containing each metal element in water according to the composition of the intended nickel composite oxide. Examples of the salt include nitrate, sulfate, and hydrochloride. When the first solution is prepared, an acidic substance (for example, a sulfuric acid aqueous solution) may be added to water. This addition may cause the salt containing each metal element to easily dissolve. In the preparation of the first solution, a basic substance may be further added to adjust the pH. The total number of moles of metal elements such as nickel in the first solution may be appropriately set according to the average particle size of the intended nickel composite oxide. Here, the total number of moles of metal elements means the total number of moles of nickel and cobalt when the first solution contains nickel and cobalt, and means the total number of moles of nickel, cobalt, and manganese when the first solution contains nickel, cobalt, and manganese.

The first solution may further contain at least one of cobalt ions, aluminum ions, and manganese ions in addition to the nickel ions. In addition to these ions, the first solution may further contain ions of at least one second metal element selected from the group consisting of magnesium, calcium, titanium, zirconium, niobium, tantalum, chromium, molybdenum, tungsten, iron, copper, silicon, tin, bismuth, gallium, yttrium, samarium, erbium, cerium, neodymium, lanthanum, cadmium, and lutetium. The second metal element may be at least one selected from the group consisting of zirconium, titanium, magnesium, tantalum, niobium, molybdenum, and tungsten.

The concentration of metal ions such as nickel and cobalt in the first solution may be, for example, in a range of 1.0 mol/L to 2.6 mol/L in total of the metal ions. The concentration of the metal ions may be preferably 1.5 mol/L or more, or 1.7 mol/L or more. The concentration of the metal ion may be preferably 2.2 mol/L or less, or 2.0 mol/L or less. When the metal ion concentration of the first solution is 1.0 mol/L or more, the amount of the crystallized product per reaction vessel can be sufficiently obtained, and thus, the productivity improves. When the metal ion concentration of the first solution is 2.6 mol/L or less, the concentration of the metal salt is suppressed from exceeding the saturation concentration at room temperature, and a decrease in the metal ion concentration in the solution due to precipitation of a metal salt crystal is suppressed.

### Second Solution Preparation Step

In the second solution preparation step, a second solution containing a complex ion forming factor is prepared. The second solution contains a complex ion forming factor that can form a complex ion with the metal ion contained in the first solution. For example, when the complex ion forming factor is ammonia, an ammonia aqueous solution can be used as the second solution. The content of ammonia contained in the ammonia aqueous solution may be, for example, in a range of 5 mass % to 25 mass %. The content of ammonia may be preferably 10 mass % or more, or 12 mass % or more. The content of ammonia may be preferably 20 mass % or less, or 18 mass % or less.

### Liquid Medium Preparation Step

In the liquid medium preparation step, a liquid medium having a pH in a range of 10 to 13.5 is prepared. The liquid medium is prepared as a solution having a pH in a range of 10 to 13.5 by using a predetermined amount of water and a basic liquid such as a sodium hydroxide aqueous in a reaction vessel. Adjusting the solution to have a pH in a range of 10 to 13.5 can suppress the pH fluctuation of the reaction solution at the initial stage of the reaction.

### Crystallization Step

In the crystallization step, the first solution and the second solution are separately and simultaneously supplied to the liquid medium while maintaining the pH of the reaction solution to be formed in a range of 10 to 13.5. In this step, composite hydroxide particles containing nickel can be obtained from the reaction solution. In addition to the first solution and the second solution, a basic solution may be simultaneously supplied to the liquid medium. This can easily maintain the pH of the reaction solution in a range of 10 to 13.5.

In the crystallization step, each solution is preferably supplied such that the pH of the reaction solution is maintained in a range of 10 to 13.5. For example, the pH of the reaction solution can be maintained in a range of 10 to 13.5 by adjusting the supply amount of the second solution in accordance with the supply amount of the first solution. When the pH of the reaction solution is 10 or more, the amount of impurities contained in the resulting composite hydroxide (for example, a sulfuric acid component and a nitric acid component other than metals contained in the reaction solution) tends to be sufficiently reduced, and a decrease in the capacity of the nonaqueous electrolyte secondary battery which is a final product tends to be suppressed. When the pH is 13.5 or less, the generation of fine secondary particles is suppressed, and the handleability of the resulting composite hydroxide may improve. The pH of the reaction solution to be maintained may be preferably 10.5 or more, or 10.9 or more, and may be preferably 11.7 or less, or 11.3 or less. The temperature of the reaction solution may be controlled to be in a range of 25° C. to 80° C., preferably in a range of 40° C. to 75° C., or in a range of 50° C. to 70° C., for example. When the pH and the temperature of the reaction solution are in the above-described ranges, particles having voids therein tend to be easily obtained. The atmosphere in the crystallization step may be a low oxidizing atmosphere, and for example, the oxygen concentration may be maintained at 10 vol % or less.

In the crystallization step, the concentration of nickel ions in the reaction solution may be maintained, for example, in a range of 10 ppm to 1000 ppm, and is preferably maintained in a range of 10 ppm to 100 ppm. When the concentration of nickel ions is 10 ppm or more, the composite hydroxide is sufficiently precipitated. When the concentration of nickel ions is 1000 ppm or less, the amount of nickel to be eluted is small, and thus, deviation from a target composition is suppressed. For example, when an ammonia aqueous solution is used as the second solution (complex ion forming solution), the nickel ion concentration can be adjusted by supplying the second solution such that the ammonium ion concentration in the reaction solution is in a range of 1000 ppm to 15000 ppm. When the ammonium ion concentration is in a range of 1000 ppm to 3000 ppm, particles having a higher porosity tend to be easily obtained.

The time for supplying the first solution may be, for example, in a range of 6 hours to 60 hours, and the time for supplying the first solution may be preferably 8 hours or more, or 10 hours or more. The time for supplying the first solution may be preferably 42 hours or less, 24 hours or less, or 18 hours or less. When the time is 6 hours or more, the precipitation rate of the composite hydroxide becomes slow, and thus, a nickel composite oxide having higher smoothness tends to be obtained. When the time is 60 hours or less, productivity can further improve.

The value obtained by setting the total number of moles of nickel and the like in the first solution supplied through the entire crystallization step as a denominator and setting the total number of moles of nickel and the like in the first solution supplied per hour as a numerator may be, for example, in a range of 0.015 to 0.125, preferably 0.020 or more, or 0.050 or more, and preferably 0.10 or less. When the value is 0.015 or more, productivity can further improve. When the value is 0.125 or less, a nickel composite oxide having a larger specific surface area tends to be obtained.

The method for producing a nickel composite oxide may include a seed generation step prior to the crystallization step. In the seed generation step, for example, by supplying a part of the prepared first solution to the liquid medium, a composite hydroxide containing nickel in the liquid medium is generated, for example, as seed crystals. That is, the liquid medium to be subjected to the crystallization step may be a seed solution containing the composite hydroxide containing nickel. The temperature in the seed generation step can be, for example, from 40° C. to 80° C. The atmosphere in the seed generation step may be a low oxidizing atmosphere, and for example, the oxygen concentration may be maintained at 10 vol % or less.

When the composite hydroxide particles are produced in advance in the liquid medium prior to the crystallization step, one particle of the composite hydroxide produced in advance serves as a seed crystal constituting one particle of the composite hydroxide to be obtained after the crystallization step. Thus, the total number of secondary particles of the composite hydroxide to be obtained after the crystallization step can be controlled by the number of composite hydroxide particles produced in advance. For example, when a large amount of the first solution is supplied in advance, the number of composite hydroxide particles to be produced increases, and thus, the average particle size of the secondary particles of the composite hydroxide after the crystallization step tends to decrease.

In the crystallization step, each of the first solution and the second solution may be continuously supplied to the liquid medium or may be intermittently supplied. The first solution may be continuously supplied over the entire supply time of the first solution in the crystallization step. Here, “continuously over the entire supply time” means that the time when supply is not made is less than 1% of the entire supply time.

### Composite Hydroxide Recovery Step

In the composite hydroxide recovery step, the composite hydroxide containing nickel is separated and recovered from the reaction solution. The recovery of the composite hydroxide from the reaction solution can be performed, for example, by separating the formed precipitate by a commonly used separation means such as filtration or centrifugation. The resulting precipitate may be subjected to treatments such as water washing, filtration, and drying. The composition ratio of the metal element in the composite hydroxide may be substantially the same as the composition ratio of the metal element other than lithium in the lithium transition metal composite oxide obtained using the composite hydroxide as a raw material.

### Composite Hydroxide Heat Treatment Step

In the composite hydroxide heat treatment step, the obtained composite hydroxide is heat treated to obtain a nickel composite oxide. Through the heat treatment, the composite hydroxide is dehydrated and a nickel composite oxide is produced. The nickel composite oxide may be a precursor of a lithium transition metal composite oxide or may be a positive electrode active material precursor.

The temperature of the heat treatment may be, for example, in a range of 105° C. to 900° C., and is preferably in a range of 300° C. to 500° C. The time for the heat treatment may be, for example, in a range of 5 hours to 30 hours, and is preferably in a range of 10 hours to 20 hours. The atmosphere of the heat treatment may be an atmosphere containing oxygen or an air atmosphere.

In the nickel composite oxide, the ratio of the number of moles of nickel to the total number of moles of metal elements contained in the nickel composite oxide may be, for example, more than 0 and less than 1. The ratio of the number of moles of nickel to the total number of moles of metal elements may be preferably 0.33 or more. The ratio of the number of moles of nickel to the total number of moles of metal elements may be 0.4 or more, or 0.45 or more. The ratio of the number of moles of nickel to the total number of moles of metal elements may be preferably 0.95 or less, 0.8 or less, or 0.6 or less.

The nickel composite oxide may contain cobalt in its composition. When the nickel composite oxide contains cobalt in its composition, the ratio of the number of moles of cobalt to the total number of moles of metal elements contained in the nickel composite oxide may be more than 0 and less than 1. The ratio of the number of moles of cobalt to the total number of moles of metal elements may be preferably 0.01 or more, 0.02 or more, 0.05 or more, 0.1 or more, or 0.15 or more. The ratio of the number of moles of cobalt to the total number of moles of metal elements is preferably 0.6 or less. The ratio of the number of moles of cobalt to the total number of moles of metal elements may be 0.4 or less, 0.35 or less, 0.33 or less, 0.3 or less, or 0.25 or less.

The nickel composite oxide may contain at least one of manganese and aluminum in its composition. When the nickel composite oxide contains at least one of manganese and aluminum in its composition, the ratio of the total number of moles of manganese and aluminum to the total number of moles of metal elements contained in the nickel composite oxide may be, for example, more than 0, preferably 0.01 or more, more preferably 0.05 or more, still more preferably 0.1 or more, and particularly preferably 0.15 or more. The ratio of the total number of moles of manganese and aluminum to the total number of moles of metal elements is, for example, 0.6 or less, preferably 0.35 or less. The ratio of the total number of moles of manganese and aluminum to the total number of moles of metal elements may be 0.33 or less, or 0.3 or less.

The nickel composite oxide may contain at least one second metal element in its composition. When the nickel composite oxide contains at least one second metal element in its composition, the ratio of the total number of moles of the second metal element to the total number of moles of the metal elements contained in the nickel composite oxide may be, for example, more than 0, 0.001 or more, or 0.003 or more. The ratio of the total number of moles of the second metal element to the total number of moles of the metal element may be, for example, 0.05 or less, 0.02 or less, 0.015 or less, or 0.01 or less.

The nickel composite oxide may have, for example, a composition represented by Formula (2) shown below:

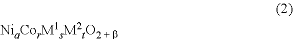

In Formula (2), M¹ represents at least one of Mn or Al. M² represents at least one selected from the group consisting of Mg, Ca, Ti, Zr, Nb, Ta, Cr, Mo, W, Fe, Cu, Si, Sn, Bi, Ga, Y, Sm, Er, Ce, Nd, La, Cd, and Lu. q, r, s, t, and β satisfy 0<q<1, 0≤r≤0.6, 0≤s≤0.6, 0≤t≤0.02, −0.1≤β≤0.1, q+r+s=1. Preferably, 0.33≤q≤0.95, 0.02≤r≤0.35, 0.01≤s≤0.35, 0≤t≤0.015. Preferably, M² is at least one selected from the group consisting of Zr, Ti, Mg, Ta, Nb, Mo, and W.

The tap density of the nickel composite oxides may be 1.3 g/cm³ or less, preferably 1.15 g/cm³ or less, more preferably 1.0 g/cm³ or less, and still more preferably 0.96 g/cm³ or less. The tap density of the nickel composite oxide may be preferably 0.2 g/cm³ or more, or 0.4 g/cm³ or more. When the tap density of the nickel composite oxide is 1.3 g/cm³ or less, the lithium transition metal composite oxide to be obtained tends to be formed into particles having a larger specific surface area. When the ratio of the number of moles of nickel to the total number of moles of metal elements contained in the nickel composite oxide is 0.5 or more, the lithium transition metal composite oxide obtained by mixing and reacting a nickel composite oxide, a lithium compound, and a tungsten compound is likely to be obtained as particles having a higher porosity, and the output characteristics tend to further improve.

The particle size of the nickel composite oxide may be in a range of 1 μm to 8 μm, and is preferably 2 μm or more, 2.5 μm or more, or 3 μm or more. The particle size of the nickel composite oxide may be preferably 6 μm or less, 5 μm or less, or 4 μm or less. When the particle size of the nickel composite oxide is in a range of 1 μm to 8 μm, the resulting lithium transition metal composite oxide tends to be particles having a larger specific surface area when the above-described tap density range is satisfied.

### Aluminum Compound

The positive electrode active material contains an aluminum compound in addition to the lithium transition metal composite oxide particles. The aluminum compound in the positive electrode active material may be present as particles of the aluminum compound independently of the lithium transition metal composite oxide particles, or at least a part of the particles of the aluminum compound may adhere to the surface of the lithium transition metal composite oxide particles. The adhesion of the particles of the aluminum compound to the surface of the lithium transition metal composite oxide particles is preferably physical adsorption from the viewpoint of flowability of the positive electrode active material as a powder. The physical adsorption may be caused by, for example, van der Waals force. It is also preferable that the adhesion of the particles of the aluminum compound to the surface of the lithium transition metal composite oxide particles does not involve a chemical reaction between the aluminum compound and the lithium transition metal composite oxide from the viewpoint of flowability of the positive electrode active material as a powder. The chemical reaction between the aluminum compound and the lithium transition metal composite oxide is promoted by, for example, heat treatment, mechanochemical treatment, or the like on a mixture of the aluminum compound and the lithium transition metal composite oxide. Thus, the positive electrode active material may be a non-heat-treated product containing the aluminum compound and the lithium transition metal composite oxide. Here, the non-heat-treated product means a product obtained without subjecting a mixture containing the aluminum compound and the lithium transition metal composite oxide to heat treatment at a temperature of 300° C. or more or 200° C. or more, for example, for 2 hours or more or 30 minutes or more. Since the positive electrode active material is a non-heat-treated product, the effect of improving the flowability by mixing an aluminum compound may be further enhanced.

Examples of the aluminum compound constituting the positive electrode active material include aluminum oxide (for example, Al₂O₃), aluminum hydroxide, aluminum chloride, aluminum nitrate, and aluminum nitride, and the positive electrode active material preferably contains at least one selected from the group consisting of these compounds. Containing a specific aluminum compound may further improve the flowability of the positive electrode active material as a powder while reducing the influence on the output characteristics and the viscosity of a slurry containing the positive electrode active material.

The average particle size of the aluminum compound may be, for example, in a range of 1 nm to less than 500 nm, and preferably 2 nm or more, 5 nm or more, or 10 nm or more from the viewpoint of the flowability of the positive electrode active material as a powder. The average particle size may be preferably 300 nm or less, 100 nm or less, or 50 nm or less. When the average particle size of the aluminum compound is within the above range, the process flowability tends to improve more efficiently. The average particle size of the aluminum compound is a volume-average particle size, and is determined as a particle size corresponding to a volume accumulation of 50% from the small size side in a volume-based cumulative particle size distribution. The volume-based cumulative particle size distribution is measured by, for example, a laser diffraction particle size distribution analyzer (SALD-3100 manufactured by Shimadzu Corporation).

The content of the aluminum compound in the positive electrode active material may be, for example, 2 mol % or less, and preferably 1.8 mol % or less, 1.5 mol % or less, or 1.0 mol % or less with respect to 1 mol of the lithium transition metal composite oxide, from the viewpoint of the output characteristics in the nonaqueous electrolyte secondary battery. The content of the aluminum compound in the positive electrode active material may be, for example, 0.01 mol % or more, and preferably 0.05 mol % or more, 0.1 mol % or more, or 0.3 mol % or more with respect to 1 mol of the lithium transition metal composite oxide, from the viewpoint of the flowability of the positive electrode active material as a powder. In an aspect, the content of the aluminum compound in the positive electrode active material may be in a range of 0.01 mol % to 2 mol % with respect to 1 mol of the lithium transition metal composite oxide.

### Tungsten Compound

The positive electrode active material may further contain a tungsten compound or may contain tungsten compound particles. When the positive electrode active material contains a tungsten compound, for example, an increase in viscosity of the slurry containing the positive electrode active material may be effectively suppressed. In particular, when the lithium transition metal composite oxide particles have a volume-average particle size of 4.7 μm or less and a specific surface area of 1.3 m²/g or more, the effect of suppressing an increase in viscosity tends to be further enhanced. The tungsten compound in the positive electrode active material may be present independently of the lithium transition metal composite oxide particles, or at least a part of the tungsten compound may adhere to the surface of the lithium transition metal composite oxide particles. At least a part of the tungsten compound may react with lithium and be contained in the positive electrode active material in the form of lithium tungstate. The adhesion of the tungsten compound to the surface of the lithium transition metal composite oxide particles is preferably physical adsorption from the viewpoint of the flowability of the slurry containing the positive electrode active material.

As the tungsten compound constituting the positive electrode active material, tungsten oxide (such as WO₃) is preferable. Containing a specific tungsten compound may suppress more effectively an increase in viscosity of the slurry containing the positive electrode active material.

The average particle size of the tungsten compound may be, for example, in a range of 0.05 μm to 2 μm, and preferably 0.25 μm or more, or 0.50 μm or more from the viewpoint of suppressing an increase in viscosity of the slurry containing the positive electrode active material. The average particle size may be preferably 1.7 μm or less or 1.5 μm or less. Here, the average particle size of the tungsten compound is a volume-average particle size, and is determined as a particle size corresponding to a volume accumulation of 50% from the small size side in a volume-based cumulative particle size distribution. The volume-based cumulative particle size distribution is measured by, for example, a laser diffraction particle size distribution analyzer (SALD-3100 manufactured by Shimadzu Corporation).

The content of the tungsten compound in the positive electrode active material may be, for example, in a range of 0.1 mol % to 2 mol % with respect to 1 mol of the lithium transition metal composite oxide. The content of the tungsten compound in the positive electrode active material may be preferably 1.8 mol % or less, 1.5 mol % or less, or 1.0 mol % or less with respect to 1 mol of the lithium transition metal composite oxide, from the viewpoint of output characteristics in the nonaqueous electrolyte secondary battery. The content of the tungsten compound in the positive electrode active material may be preferably 0.2 mol % or more, 0.3 mol % or more, or 0.5 mol % or more with respect to 1 mol of the lithium transition metal composite oxide from the viewpoint of suppressing an increase in viscosity of the slurry containing the positive electrode active material.

### Step 2: Formation of Positive Electrode Active Material Layer

Step 2 is a step of forming a positive electrode active material layer. The step of forming a positive electrode active material layer includes dispersing the positive electrode active material, a conduction aid, and a binder in a solvent, applying the dispersion to a current collector, drying the dispersion, and compression-molding the resultant to have a density of more than 2.6 g/cm³ and less than 2.8 g/cm³. A nonaqueous electrolyte secondary battery including an electrode having such a positive electrode active material layer can achieve excellent output characteristics.

The positive electrode active material layer is disposed on a current collector and constitutes an electrode for a nonaqueous electrolyte secondary battery together with the current collector.

The density of the positive electrode active material layer may be, for example, more than 2.6 g/cm³ and less than 2.8 g/cm³, and preferably 2.7 g/cm³. The density of the positive electrode active material layer is calculated by dividing the mass of the positive electrode active material layer by the volume of the positive electrode active material layer. Here, the density of the positive electrode active material layer can be adjusted by applying an electrode composition to be described later on the current collector and then applying pressure.

The mass of the positive electrode active material layer is obtained by subtracting the mass of the current collector from the mass of the electrode. The volume of the positive electrode active material layer is obtained by multiplying the area of the electrode by the height of the positive electrode active material layer. The height of the positive electrode active material layer can be measured by using, for example, Speed Micro Mini (manufactured by Marui Techno Co., Ltd.).

Examples of the material of the current collector include aluminum, nickel, and stainless steel. The positive electrode active material layer can be formed by applying an electrode composition obtained by mixing the positive electrode active material, a conduction aid, a binder, and the like together with a solvent onto a current collector, and performing a drying treatment, a pressure treatment, and the like.

Examples of the conduction aid include natural graphite, artificial graphite, and acetylene black. Examples of the binder include polyvinylidene fluoride, polytetrafluoroethylene, and polyamide acrylic resin. Examples of the solvent include N-methyl-2-pyrrolidone (hereinafter also referred to as “NMP”).

### Nonaqueous Electrolyte Secondary Battery

The nonaqueous electrolyte secondary battery includes the electrode for a nonaqueous electrolyte secondary battery. The nonaqueous electrolyte secondary battery includes a negative electrode for a nonaqueous electrolyte secondary battery, a nonaqueous electrolyte, a separator, and the like in addition to the electrode for a nonaqueous electrolyte secondary battery. As the negative electrode, the nonaqueous electrolyte, the separator, and the like in the nonaqueous electrolyte secondary battery, for example, those for a nonaqueous electrolyte secondary battery described in JP 2002-075367 A, JP 2011-146390 A, JP 2006-12433 A (these are incorporated herein by reference in their entirety), and the like can be appropriately used.

The present disclosure is not limited to the above embodiment. The above-described embodiment is an example, and it goes without saying that anything having substantially the same configuration as the technical idea described in the claims of the present disclosure and exhibiting the same operation and effect is included in the technical scope of the present disclosure.

### EXAMPLES

The present invention will be described in detail below through examples, but the present invention is not limited to these examples. Hereinafter, the volume-average particle size was evaluated using a laser diffraction particle size distribution measuring apparatus (SALD-3100 manufactured by Shimadzu Corporation). The specific surface area was measured using a BET specific surface area measuring apparatus (manufactured by Mountech Co., Ltd.; Macsorb) by a nitrogen gas adsorption method (one-point method). The porosity was evaluated by a method using the above-described scanning electron microscope (SEM) and image analysis software (for example, HALCON; manufactured by MVTec).

### Example 1

### Production of Positive Electrode Active Material

### Preparation of Solutions

A nickel sulfate solution, a cobalt sulfate solution, and a manganese sulfate solution were dissolved and mixed in water such that the molar ratio of the metal elements was 35:35:30 to prepare a first solution (the total concentration of nickel ions, cobalt ions, and manganese ions was 1.7 mol/L). The total number of moles of the metal elements in the first solution was 350 moles. A 25 wt. % sodium hydroxide aqueous solution was prepared as a basic solution. As a second solution (complex ion forming solution), a 12.5 wt. % ammonia aqueous solution was prepared.

### Preparation of Liquid Medium

In a reaction vessel, 30 liters of water was prepared, and an aqueous sodium hydroxide solution was added to obtain a pH of 12.5. Nitrogen gas was introduced and the inside of the reaction vessel was replaced with nitrogen to prepare a liquid medium as a pre-reaction solution.

### Seed Generation Step

While the liquid medium was stirred, the first solution was added to the liquid medium in an amount of 10 moles in terms of the total number of moles of nickel and the like to precipitate a composite hydroxide containing nickel, cobalt, and manganese.

### Crystallization Step

The remaining first solution of 340 moles, the aqueous sodium hydroxide solution, and the second solution were supplied over 12 hours while stirring the reaction solution so that the ammonium ion concentration was about 4000 ppm while the pH was maintained in a range about from 10.9 to 11.3 in the reaction solution, whereby a composite hydroxide containing nickel, cobalt, and manganese was precipitated. The temperature of the reaction solution was controlled to be about 60° C. The precipitate was washed with water, filtered, separated, and then dried to obtain a composite hydroxide (hereinafter, also referred to as nickel-cobalt composite hydroxide) containing nickel, cobalt, and manganese. The nickel-cobalt composite hydroxide was subjected to heat treatment at 320° C. for 16 hours in an air atmosphere, and was recovered as a transition metal composite oxide containing nickel, cobalt, and manganese (hereinafter also referred to as a composite oxide). The obtained composite oxide had a volume-average particle size of 4.7 μm and a tap density of 0.86 g/cm³.

### Synthesis Step

The obtained composite oxide was mixed with lithium carbonate, zirconium (IV) oxide, and tungsten (VI) oxide at Li:(Ni+Co+Mn):Zr:W=1.19:1:0.005:0.003 (molar ratio) to obtain a lithium mixture. The obtained lithium mixture was heat treated in an air atmosphere. The heat treatment was performed at a first temperature of 780° C. for 2 hours and at a second temperature of 910° C. for 4 hours to obtain a heat-treated product. The obtained heat-treated product was pulverized and passed through a dry sieve to obtain a lithium transition metal composite oxide represented by the composition formula Li_{1.19}Ni_{0.35}Co_{0.35}Mn_{0.30}Zr_{0.005}W_{0.003}O₂.

The volume-average particle size of the lithium transition metal composite oxide as a base material was 4.4 μm, the specific surface area was 2.06 m²/g, and the porosity was 30%.

### Mixing Step

The lithium transition metal composite oxide obtained as described above was mixed with aluminum oxide (Al₂O₃: manufactured by CABOT Corporation; volume-average particle size 20 nm to 30 nm) as an aluminum compound to obtain a ratio of (Ni+Co+Mn):Al=1:0.005 (molar ratio) with respect to the lithium transition metal composite oxide, and then mixed with a high-speed shear mixer. Thereafter, the mixture was passed through a dry sieve to obtain a positive electrode active material of Example 1.

The obtained positive electrode active material of Example 1 had a volume-average particle size of 4.4 μm, a specific surface area of 2.26 m²/g, and a porosity of 30%.

### Reference Example 1

A positive electrode active material of Reference Example 1 was obtained in the same manner as in Example 1 except that in the mixing step, in addition to the aluminum compound, tungsten oxide (WO₃: manufactured by Japan New Metals Co., Ltd.; average particle size 1000 nm) was further added as a tungsten compound to obtain a ratio of (Ni+Co+Mn):Al:W=1:0.005:0.005 (molar ratio) with respect to the lithium transition metal composite oxide.

### Preparation of Positive Electrode

The positive electrode active material in an amount of 92 parts by mass, 3 parts by mass of acetylene black, and 5 parts by mass of polyvinylidene fluoride (PVDF) were dispersed in N-methyl-2-pyrrolidone (NMP) to prepare a positive electrode mixture slurry. The obtained positive electrode mixture slurry was applied to an aluminum foil as a current collector, dried, compression-molded by a roll press machine, and cut into a predetermined size to produce a positive electrode. The density of the positive electrode active material layer was calculated by dividing the mass of the positive electrode active material layer by the volume of the positive electrode active material layer, and density was found to be 2.7 g/cm³.

### Fabrication of Battery for Evaluation

Using the positive electrode obtained above, a battery for evaluation was produced according to the following procedure.

### Production of Negative Electrode

Artificial graphite in an amount of 97.5 parts by mass, 1.5 parts by mass of carboxymethyl cellulose (CMC), and 1.0 parts by mass of SBR (styrene butadiene rubber) were dispersed and dissolved in pure water to prepare a negative electrode slurry. The obtained negative electrode slurry was applied to a current collector made of copper foil, dried, compression-molded by a roll press machine, and cut into a predetermined size to prepare a negative electrode.

After a lead electrode was attached to each current collector of the positive electrode and the negative electrode, a separator was disposed between the positive electrode and the negative electrode, and they were housed in a bag-shaped laminate pack. Subsequently, the obtained material was vacuum-dried at 65° C. to remove moisture adsorbed to members. Thereafter, an electrolytic solution was injected into the laminate pack under an argon atmosphere and sealed to produce a battery for evaluation. As the electrolytic solution, a solution obtained by mixing ethylene carbonate (EC) and methyl ethyl carbonate (MEC) at a volume ratio of 3:7 and dissolving lithium hexafluorophosphate (LiPF₆) at a concentration of 1 mol/L was used.

### Comparative Example 1

A battery for evaluation of Comparative Example 1 was produced in the same manner as in Example 1 except that in the production of the positive electrode, the pressurization of the roll press machine was adjusted so that a density of the positive electrode active material layer was changed to 2.5 g/cm³.

### Comparative Example 2

A battery for evaluation of Comparative Example 2 was produced in the same manner as in Example 1 except that in the production of the positive electrode, the pressurization of the roll press machine was adjusted so that a density of the positive electrode active material layer was changed to 2.9 g/cm³.

### Comparative Example 3

A composite oxide containing nickel, cobalt, and manganese having a volume-average particle size of 3.4 μm and a tap density of 1.46 g/cm³ was obtained in the same manner as in Example 1 except that in the crystallization step, the pH of the reaction solution was maintained at about 11.3 to 11.7, the ammonium ion concentration was set to about 6000 ppm, the temperature of the reactant was controlled to about 45° C., and the supply time of the first liquid in the crystallization step was set to 18 hours. A lithium transition metal composite oxide was obtained in the same manner as in the synthesis step of Example 1 except that the obtained composite oxide was used.

The obtained lithium transition metal composite oxide was used as a positive electrode active material. The positive electrode active material had a volume-average particle size of 3.1 μm, a specific surface area of 1.09 m²/g, and a porosity of 5%.

Using the positive electrode active material obtained above, a battery for evaluation of Comparative Example 3 was produced in the same manner as in the production of the positive electrode and the production of the battery for evaluation of Example 1.

### Comparative Example 4

A battery for evaluation of Comparative Example 4 was produced in the same manner as in Comparative Example 3 except that in the production of the positive electrode, the pressurization of the roll press machine was adjusted so that the density of the positive electrode active material layer was changed to 2.5 g/cm³.

### Comparative Example 5

A battery for evaluation of Comparative Example 5 was produced in the same manner as in Comparative Example 3 except that in the production of the positive electrode, the pressurization of the roll press machine was adjusted so that the density of the positive electrode active material layer was changed to 2.9 g/cm³.

### Comparative Example 6

The lithium transition metal composite oxide as a base material obtained in Example 1 was used as a positive electrode active material in the same manner as in Example 1 except that the mixing step was not performed. A battery for evaluation of Comparative Example 6 was produced in the same manner as in the production of the positive electrode and the production of the battery for evaluation of Example 1.

### Comparative Example 7

A battery for evaluation of Comparative Example 7 was produced in the same manner as in Comparative Example 6 except that in the production of the positive electrode, the pressurization of the roll press machine was adjusted so that the density of the positive electrode active material layer was changed to 2.5 g/cm³.

### Comparative Example 8

A battery for evaluation of Comparative Example 8 was produced in the same manner as in Comparative Example 6 except that in the production of the positive electrode, the pressurization of the roll press machine was adjusted so that the density of the positive electrode active material layer was changed to 2.9 g/cm³.

### Evaluation

### Evaluation of Process Flowability

About 50 g of each of the positive electrode active materials used in Example 1, Comparative Example 3, and Comparative Example 6 and the positive electrode active material of Reference Example 1 was weighed and put on a powder characteristic measuring instrument (Powder Tester (trade name); manufactured by Hosokawa Micron Corporation). Thereafter, the angle of repose and the angle of fall were automatically measured, and the angle of difference was calculated. The results are indicated in Table 1 below.

### Evaluation of Viscosity of Positive Electrode Mixture Slurry

The positive electrode active materials used in Example 1, Comparative Example 3, and Comparative Example 6 and the positive electrode active material of Reference Example 1 were used to produce positive electrode mixture slurries as described below, and the viscosities of the positive electrode mixture slurries were evaluated.

### Preparation of Positive Electrode Mixture Slurry

Each positive electrode active material in an amount of 89.5 parts by mass, 5 parts by mass of acetylene black as a conduction aid, 5 parts by mass of polyvinylidene fluoride (PVDF) as a binder, and 0.5 parts by mass of polyvinylpyrrolidone (PVP) as a dispersant were dispersed in N-methyl-2 pyrrolidone (NMP) to prepare a positive electrode mixture slurry.

### Evaluation of Relative Thickening Rate

Each positive electrode mixture slurry prepared above was measured for viscosity immediately after slurry preparation and 6 hours after slurry preparation using an E-type viscosimeter (HAAKE Viscotester 550, manufactured by Thermo Scientific Inc.). A value obtained by dividing the viscosity of the positive electrode mixture slurry 6 hours after the preparation by the viscosity immediately after the preparation was defined as the thickening rate according to the following formula. (slurry viscosity after 6 hours)/(slurry viscosity immediately after preparation)

The obtained thickening rate was evaluated as a relative thickening rate when the thickening rate of Comparative Example 3 was set to 1. The results are indicated in Table 1 below.

TABLE 1

| | | Specific | | Angle of | Angle | Angle of | Relative |
|---|---|---|---|---|---|---|---|
| | D50 | surface | | repose | of fall | difference | thickening |
| | (μm) | area (m²/g) | Porosity | (°) | (°) | (°) | rate |
| Example 1 | 4.4 | 2.26 | 30 | 66 | 57 | 9 | 1.15 |
| Comparative | 3.1 | 1.09 | 5 | 65 | 61 | 4 | 1 |
| Example 3 | | | | | | | |
| Comparative | 4.4 | 2.06 | 30 | 70 | 68 | 2 | 1.14 |
| Example 6 | | | | | | | |
| Reference | 4.4 | 2.29 | 30 | 64 | 55 | 9 | 0.94 |
| Example 1 | | | | | | | |

In the positive electrode active materials of Examples and Reference Example 1 containing the aluminum compound, the angle of difference was large, and improvement in flowability was observed. Further, in Reference Example 1 containing the tungsten compound, a decrease in the relative thickening rate was observed.

The batteries for evaluation obtained in Example 1 and Comparative Examples 2 to 8 were placed in a constant temperature bath at 25° C., aged with a weak current, and then evaluated as follows.

### Evaluation of Cycle Characteristics (Measurement of Cycle Capacity Retention Rate)

The produced batteries for evaluation were subjected to constant-current charging and discharging 200 times at a charging and discharging rate from 2.75 V to 4.2 V at a charge-discharge rate of 1.0 C under the measurement condition of 60° C. using a charge and discharge tester. At the time of charging, constant voltage charging was performed after the voltage reached 4.2 V, and charging was terminated when the current value became equivalent to 0.05 C. In the batteries for evaluation using the positive electrode active materials in a dense particle form of Comparative Examples 3, 4, and 5, the capacity retention rate was significantly lower than that of the battery for evaluation using the positive electrode active material in a sparse particle form. It is considered that this is because the dense particles have poor contact with the conduction aid as compared with the sparse particles. Further, the batteries for evaluation using the positive electrode active materials containing the aluminum compound of Example 1, Comparative Example 1, and Comparative Example 2 had slightly higher capacity retention rates than the batteries for evaluation using the positive electrode active materials of Comparative Examples 6 to 8. The following reasons are conceivable. In the positive electrode active materials of Example 1, Comparative Example 1, and Comparative Example 2, elution of the active material was suppressed by the aluminum compound covering the positive electrode active materials, and the capacity retention rate improved.

Evaluation of Output Characteristics (Measurement of Direct Current Internal Resistance) The direct current internal resistance (DC-IR) was measured for each battery for evaluation after aging. After constant current charge was performed up to a charge depth of 50% at a full charge voltage of 4.2 V, the battery for evaluation was placed in an environment of −25° C., pulse discharge with a specific current i was performed for 10 seconds, and a voltage V at 10 seconds was measured. The current i was plotted on the horizontal axis, the voltage V was plotted on the vertical axis, and the slope of the straight line connecting the intersections was taken as the direct current internal resistance (DC-IR). The current i was set to 0.02 A, 0.04 A, 0.06 A, 0.08 A, and 0.10 A. Having a low DC-IR means having favorable output characteristics.

The results of the obtained direct current internal resistance are shown in the following table. In Example 1 and Comparative Examples 1 and 2, the battery for evaluation according to Example 1 had the lowest direct current internal resistance. It is considered that this is because, in the positive electrode active material in the present disclosure, when the electrode plate density is set to 2.7 g/cm³, the balance of the contact between the positive electrode active material and the electrolytic solution, the contact between the positive electrode active materials, and the contact between the positive electrode active material and the conduction aid becomes the best.

TABLE 2

| | | | | | Electrode | | |
|---|---|---|---|---|---|---|---|
| | | | | | plate | DC- | Capacity |
| | Particle | Aluminum | BET | | density | IR | retention |
| | form | compound | m²/g | Porosity % | (g/cm³) | (Ω) | rate (%) |
| Example 1 | Sparse | Contained | 2.26 | 30 | 2.7 | 9 | 93 |
| Comparative | Sparse | Contained | 2.26 | 30 | 2.5 | 9.2 | 91 |
| Example 1 | | | | | | | |
| Comparative | Sparse | Contained | 2.26 | 30 | 2.9 | 9.4 | 93 |
| Example 2 | | | | | | | |
| Comparative | Dense | None | 1.09 | 5 | 2.7 | 9.6 | 76 |
| Example 3 | | | | | | | |
| Comparative | Dense | None | 1.09 | 5 | 2.5 | 10.8 | 60 |
| Example 4 | | | | | | | |
| Comparative | Dense | None | 1.09 | 5 | 2.9 | 10.2 | 79 |
| Example 5 | | | | | | | |
| Comparative | Sparse | None | 2.26 | 30 | 2.7 | 9.4 | 88 |
| Example 6 | | | | | | | |
| Comparative | Sparse | None | 2.26 | 30 | 2.5 | 9.8 | 90 |
| Example 7 | | | | | | | |
| Comparative | Sparse | None | 2.26 | 30 | 2.9 | 9.7 | 92 |
| Example 8 | | | | | | | |

From the above results, it was confirmed that the positive electrode active material used in Example 1 was excellent in flowability, and that the battery including the positive electrode active material layer having a density of 2.7 g/cm³ using the positive electrode active material was excellent in both output characteristics and cycle characteristics.

The present disclosure includes the following embodiments.

(1)

A method for producing a positive electrode for a nonaqueous electrolyte secondary battery, the nonaqueous electrolyte secondary battery comprising a current collector and a positive electrode active material layer disposed on the current collector, the method comprising:
obtaining a positive electrode active material having a volume-average particle size in a range of 1 μm to 8 μm and a specific surface area of 1.4 m²/g or more from: particles containing a lithium transition metal composite oxide; and an aluminum compound having a volume-average particle size in a range of 1 nm to less than 500 nm; and obtaining a positive electrode active material layer by dispersing the positive electrode active material, a conduction aid, and a binder in a solvent to obtain a dispersion, applying the dispersion to the current collector, drying the dispersion, and subsequently compression-molding the dispersion and the current collector to have a density of more than 2.6 g/cm³ and less than 2.8 g/cm³.

(2)

The method for producing a positive electrode for a nonaqueous electrolyte secondary battery according to Embodiment 1, wherein the lithium transition metal composite oxide contains lithium and nickel in a composition and has a layered structure.

(3)

The method for producing a positive electrode for a nonaqueous electrolyte secondary battery according to Embodiment 1 or 2, wherein the particles containing the lithium transition metal composite oxide have an internal porosity of 10% or more.

(4)

The method for producing a positive electrode for a nonaqueous electrolyte secondary battery according to any one of Embodiments 1 to 3, wherein the positive electrode active material has a specific surface area in a range of 1.7 m²/g to 3.3 m²/g.

(5)

The method for producing a positive electrode for a nonaqueous electrolyte secondary battery according to any one of Embodiments 1 to 4, wherein a content of the aluminum compound in the positive electrode active material is in a range of 0.01 mol % to 2 mol % with respect to the lithium transition metal composite oxide.

(6)

The method for producing a positive electrode for a nonaqueous electrolyte secondary battery according to any one of Embodiments 1 to o5, wherein the positive electrode active material further comprises a tungsten compound.

(7)

The method for producing a positive electrode for a nonaqueous electrolyte secondary battery according to Embodiment 6, wherein a content of the tungsten compound is in a range of 0.1 mol % to 2 mol % with respect to the lithium transition metal composite oxide.

(8)

A positive electrode for a nonaqueous electrolyte secondary battery, the positive electrode comprising a current collector and a positive electrode active material layer disposed on the current collector, wherein the positive electrode active material layer is obtained from a dispersion containing a positive electrode active material, the positive electrode active material containing: particles containing a lithium transition metal composite oxide; and an aluminum compound having a volume-average particle size in a range of 1 nm to less than 500 nm, the positive electrode active material having a volume-average particle size in a range of 1 μm to 8 μm and a specific surface area of 1.4 m²/g or more, and the positive electrode active material layer has a density of more than 2.6 g/cm³ and less than 2.8 g/cm³.

What is claimed is:

1. A method for producing a positive electrode for a nonaqueous electrolyte secondary battery, the nonaqueous electrolyte secondary battery comprising a current collector and a positive electrode active material layer disposed on the current collector, the method comprising:
obtaining a positive electrode active material having a volume-average particle size in a range of 1 μm to 8 μm and a specific surface area that is 1.4 m²/g or more from: particles containing a lithium transition metal composite oxide; and an aluminum compound having a volume-average particle size in a range of 1 nm to less than 500 nm; and
obtaining the positive electrode active material layer by dispersing the positive electrode active material, a conduction aid, and a binder in a solvent to obtain a dispersion, applying the dispersion to the current collector, drying the dispersion, and subsequently compression-molding the dispersion and the current collector to have a density in a range of more than 2.6 g/cm³ and less than 2.8 g/cm³.

2. The method for producing a positive electrode for a nonaqueous electrolyte secondary battery according to claim 1, wherein the lithium transition metal composite oxide contains lithium and nickel in a composition and has a layered structure.

3. The method for producing a positive electrode for a nonaqueous electrolyte secondary battery according to claim 1, wherein the particles containing the lithium transition metal composite oxide have an internal porosity that is 10% or more.

4. The method for producing a positive electrode for a nonaqueous electrolyte secondary battery according to claim 1, wherein the positive electrode active material has a specific surface area in a range of 1.7 m²/g to 3.3 m²/g.

5. The method for producing a positive electrode for a nonaqueous electrolyte secondary battery according to claim 1, wherein a content of the aluminum compound in the positive electrode active material is in a range of 0.01 mol % to 2 mol % with respect to the lithium transition metal composite oxide.

6. The method for producing a positive electrode for a nonaqueous electrolyte secondary battery according to claim 1, wherein the positive electrode active material further comprises a tungsten compound.

7. The method for producing a positive electrode for a nonaqueous electrolyte secondary battery according to claim 6, wherein a content of the tungsten compound is in a range of 0.1 mol % to 2 mol % with respect to the lithium transition metal composite oxide.

8. A positive electrode for a nonaqueous electrolyte secondary battery, the positive electrode comprising a current collector and a positive electrode active material layer disposed on the current collector,
wherein the positive electrode active material layer is obtained from a dispersion containing a positive electrode active material, the positive electrode active material containing: particles containing a lithium transition metal composite oxide; and an aluminum compound having a volume-average particle size in a range of 1 nm to less than 500 nm, and
wherein the positive electrode active material having a volume-average particle size in a of from 1 μm to 8 μm and a specific surface area that is 1.4 m²/g or more, and the positive electrode active material layer has a density in a range of more than 2.6 g/cm³ and less than 2.8 g/cm³.
